(19) United States
(12) Patent Application Publication
(10) Pub. No.: US 2005/0147542 A1
(43) Pub. Date: Jul. 7, 2005

(54) Fluorescent lamp disposal system

(76) Inventor: Edward J. Domanico, Weston, FL (US)

Correspondence Address: DANIEL S. POLLEY, P.A., 1215 EAST BROWARD BOULEVARD, FORT LAUDERDALE, FL, 33301, US

(21) Appl. No.: 10/330,814

(22) Filed: Dec. 27, 2002

Related U.S. Application Data
(63) Continuation of application No. 09/540,410, filed on Mar. 31, 2000, now abandoned.
(60) Provisional application No. 60/127,381, filed on Apr. 1, 1999.

(51) Int. Cl. B09B 3/00

(52) U.S. Cl. 422/184.1

(57) ABSTRACT

A chemical waste collection and disposal system for fluorescent lamps that allows for the safe collection and disposal of crushed or broken fluorescent lamps, while recovering substantially 100% of the hazardous mercury vapors contained within the lamps. A fluorescent lamp is inserted and is by a spinner assembly, having one or more blades that break the fluorescent lamp into fragments that collect at the bottom of the drum. The mercury vapors that are emitted from the broken fluorescent lamps are forced out of the drum with positive pressure created by a vacuum/filter assembly. Once through the vacuum/filter assembly, the vapors exit the vacuum/filter assembly and enter an activated carbon filter. Once through the filter the gases are permitted to escape virtually 100% free of mercury toxins.

This application is a continuation of U.S. application Ser. No. 09/540,410, Filed Mar. 31, 2000, which claims priority to and the benefit of U.S. Application No. 60/127,381, filed Apr. 1, 1999.

### BACKGROUND OF THE INVENTION

This invention relates generally to the collection, storage and disposal of chemical wastes, especially upon cruise and cargo vessels, and particularly to the collection, storage and disposal of fluorescent lamps and the recovery of mercury vapors emitted from said fluorescent lamps.

There are several problems associated with the collection and disposal of fluorescent lamps, which generate waste on ships and upon large ships in general. The operators, i.e., ship employees, of on-board chemical waste collection and disposal systems are often unknowledgeable about the proper use of present-day waste collection systems. Such operators are typically not aware of procedures for safe and code compliance handling of the waste and, therefore are not able to properly handle storage, movement, leakage or spillage of chemical waste.

Further, the common practice for ship employees to dispose of fluorescent lamps does not include the use of on-board chemical waste collection and disposal systems. Instead, the common practice is to dispose the fluorescent lamps with common non-chemical waste. This procedure results in the breakage of the fluorescent lamps and allows mercury vapors to emit from the fluorescent lamps and contaminate the immediate area thereby possibly intoxicating the ship employees' work area and also possibly causing serious health and safety violations.

The Occupational Safety and Health Administration (OSHA) has set Permissible Exposure Limits (PEL) for the number of air contaminants in the Code of Federal Regulations for Labor and Industry (29 CFR 1910.1000). The PEL's are based upon an 8-hour Time Weighted Average (TWA) concentration. An employees' exposure to a substance for an 8-hour work shift of a 40-hour work week should not exceed the 8-hour TWA PEL for that substance. For substances with a Ceiling Limit, the concentration shall not exceed that limit at any time during the working exposure. For Mercury, the OSHA PEL is, 0.1 mg/m3 (C) pursuant to 29 C.F.R. 1910.1000 (z) (2).

As such, it is highly desirous to provide a chemical waste collection, storage and disposal system for the safe handling of fluorescent lamps upon their useful life ending. It is therefore, to the effective resolution of the aforementioned problems and shortcomings that the present invention is directed.

### SUMMARY OF THE INVENTION

The present invention is a chemical waste collection and disposal system for fluorescent lamps which preferably includes a drum or container such as a 55-gallon Department of Transportation (D.O.T.) standard drum, a drum lid assembly with handles at the top thereof, a bottom, an interior hollow volume, a fixed lamp tube on the drum-lid for entry of fluorescent lamp tubes, a motor assembly attached on the drum-lid, a vacuum/filter unit attached on the side of the drum preferably near the top, and a filter located at the exterior of the side near the top of the drum.

This invention, preferably mounted on the drum allows for the safe collection and disposal of properly crushed fluorescent lamps, while recovering 100% of the hazardous mercury vapors. Any length fluorescent lamps can be disposed of, such as standard one inch and four or eight foot lamps. Where a standard 55-gallon drum is used, the present invention can disposed of approximately 600 four foot lamps, though such number is not limiting. Thus, the present invention may be utilized to safely collect and store any length fluorescent lamp, including standard 4 and 8-foot lamps, and the most recent 1″ lamps. In use, a fluorescent lamp is inserted into an opening of the fixed lamp tube assembly, preferably at the top of the tube assembly. Upon reaching the bottom opening of the fixed lamp tube, the fluorescent lamp is met by a spinner assembly or the like, that is driven by a motor assembly. Rotating at a sufficient amount of revolutions per second, one or more blades of the spinner assembly, breaks the fluorescent lamp into fragments that collect at the bottom of the drum.

The mercury vapors that are emitted from the broken fluorescent lamps are preferably forced out of the drum with positive pressure created by the vacuum/filter assembly. Once through the vacuum/filter assembly, the vapors exit said vacuum/filter assembly and preferably enter an activated carbon filter or the like. Upon the gases and vapors filtering through the activated carbon filter, they escape out of a vent member virtually 100% free of mercury toxins, as the toxins remain with the carbon filter.

The controls of the instant invention allow for fluorescent lamps to be safely disposed of while maintaining concentrations of mercury within the ceiling limit established by OSHA. Preferably, one lamp is inserted through the assembly at a time. However, it is considered within the scope of the invention to inserted more than one lamp through the assembly. In such alternative embodiment, the size of the components such as the tube assembly will be adjusted accordingly. It is also within the scope of the invention, to use the present invention for the disposal of other potential hazardous objects. With these alternative uses, certain components like the activated carbon may be replaced, where applicable, with a more appropriate chemical needed for neutralizing or retaining the additional hazardous material, which may not be mercury.

Accordingly, it is an object of the present invention to provide a chemical waste collection and disposal system which is easily operable by a crew aboard a cruise or large ship.

It is another object to provide a chemical waste storage and disposal system which allows for safe and code compliance storage of chemical waste.

It is a yet further object to provide a chemical waste and storage system which is easily transportable off ship for removal and disposal.

It is a yet further object to provide a chemical waste and storage system which is easily movable from drum to drum.

It is a further object of the invention to allow for the safe collection and disposal of fluorescent lamps.

It is still another object of the invention to provide a chemical waste and disposal system in which mercury particles and vapors that are emitted from fluorescent lamps are safely contained upon disposal.

It is a yet further object to provide for the economical transport of chemical waste in unit quantities as close to 55 gallons as possible, for cost-effective operation of the system.

The above and yet further objects and advantages of the present inventive system will become apparent from hereinafter set forth Brief Description of the Drawings and Detailed Description of the Invention.

### BRIEF DESCRIPTION OF THE DRAWINGS

The invention may be better understood by reference to the drawings in which:

FIG. 1 is a perspective view of a preferred embodiment of the chemical waste collection, storage and disposal system;

FIG. 2 is a top view of the embodiment illustrated in FIG. 1; and

FIG. 3 is a side plan view of FIG. 1, illustrating a motor assembly and a fixed lamp tube.

### DETAILED DESCRIPTION OF THE DRAWINGS

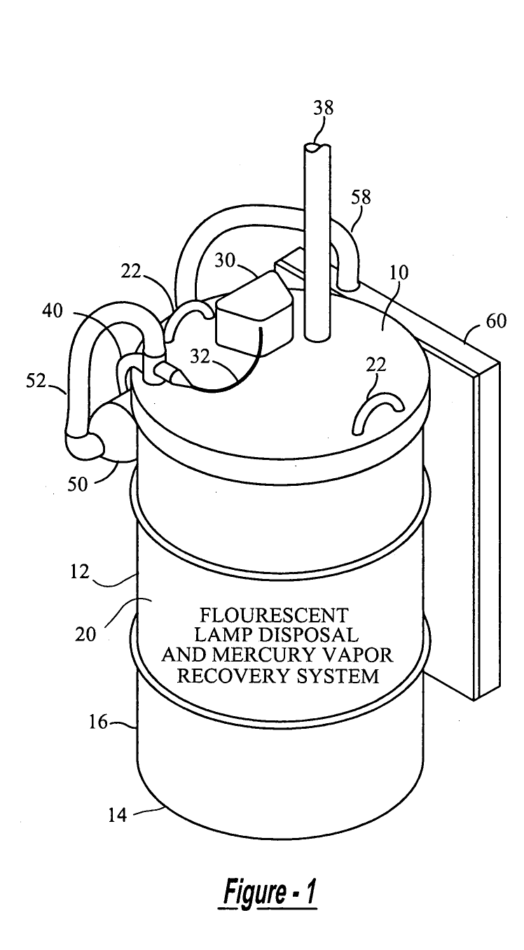

A preferred embodiment of the instant chemical waste collection and disposal system, as is illustrated in FIG. 1, comprises a drum lid assembly 10, mounted preferably on a drum or other housing, such as a 55-gallon D.O.T. standard drum 20, having a drum bottom 14, a drum exterior 12, and a drum interior hollow volume 16. The drum-lid assembly 10, includes at least one handle and preferably two handles 22, and a fixed lamp tube 38, preferably shaped to correspond to the shape of the fluorescent lamps, or other items, to be inserted.

The fixed lamp tube 38, is preferably adjacent to a motor assembly 30. Motor assembly 30 may be of a 120V or 220V configuration and powered by an electrical cord, other power configurations including battery power are also within the scope of the invention. As illustrated in FIG. 3, the fixed lamp tube 38, preferably has an opening at the top to allow for a fluorescent lamp 70 to be inserted preferably vertically into the opening. Upon reaching the bottom opening of fixed lamp tube 38, the fluorescent lamp is met by a spinner assembly 36, connected to a shaft 34, which is driven by a motor-assembly 30. Rotating at a sufficient amount of revolutions per second, the blades of spinner assembly 36, break the fluorescent lamp into fragments that fall to the bottom of the drum, through an opening in the drum cover or lid.

As illustrated in FIG. 1, the mercury vapors that are emitted from the broken fluorescent lamps may be drawn out of the 55-gallon drum by a positive pressure created by the mercury vapor recovery system that features a high-efficiency vacuum system 50, through flexible hose 52. Vacuum/filter assembly 50 is preferably attached to the 55-gallon drum by a bracket 40. The high efficiency vacuum system 50 preferably includes a specially treated H.E.P.A. filter that captures virtually 100% of the mercury, contaminated white powder, considered hazardous. It should be recognized that other appropriate conventional filters can also be used and are considered within the scope of the invention. Preferably, the filters are replaced periodically.

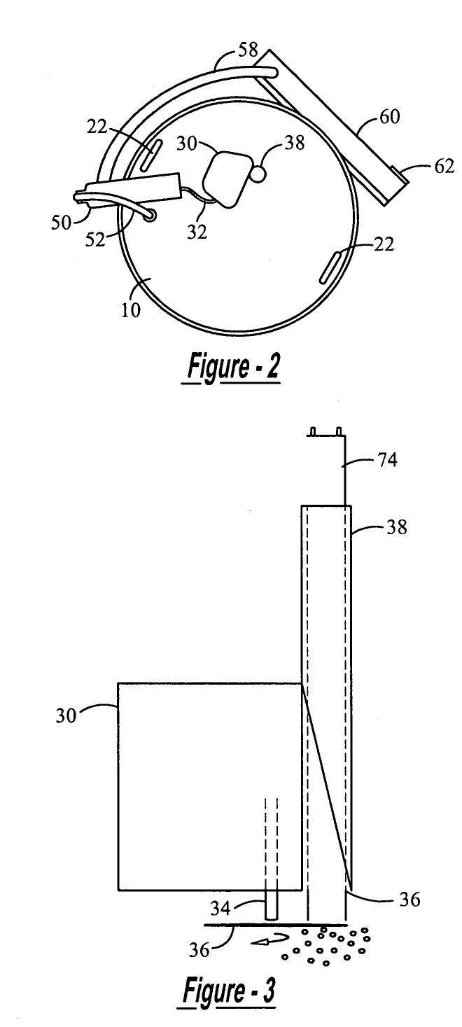

As illustrated in FIG. 2, once drawn through vacuum/filter assembly 50, the vapors then exit the vacuum/filter assembly through flexible hose 58 and then preferably enter a specially treated activated carbon filtering system 60 for final hazardous mercury vapor removal. Other conventional filtering systems can also be used and are considered within the scope of the invention. Upon the gases and vapors filtering through activated carbon filter 60, they are exhausted out of a vent 62 as uncontaminated air, free of harmful mercury toxins, which are retained or neutralized by the filter.

The present invention, in its preferred embodiment, includes the following parts and components, namely:

I. Main Drum-Lid Assembly

(a) lid, with fixed lamp tube
(b) lamp tube, loose, with funnel top
(c) lid handle, (2), with ¼-20×1″ and 2″ screws and locknuts
   II. Motor Assembly
(a) motor, replacement, 120 v, with top disk, washers, locknuts, switch, no cords
(b) motor, replacement, 120 v, with top disk, washers, locknuts, switch, short and long cords
(c) motor, replacement, 120/220 v, with top disk, washers, locknuts, switch, no cords
(d) motor, replacement, 120/220 v, with top disk, washers, locknuts, switch, short and long cords
(e) spinner assembly, with hub, cable, and set screws
(f) power cord, 18-3 SJT, 40′ with wire nuts and strain relief
(g) cord, short, to vacuum filter section cable and connector (6″ cord)
(h) switch, on-off toggle switch, with nuts and legend plate, wire nuts
   III. Filter/Vacuum Section
(a) vacuum unit, with connectorized cord and screws for mounting to bracket.
(b) vacuum mounting bracket
(c) bracket mounting spacers, (3), ¾ diameter×1″
(d) hose, inlet replacement, with tapered end piece
(e) hose, outlet replacement, with tapered end piece
(f) hose grommets, (2), for lid and carbon canister
(g) filter bags, disposable pre-filters, set of 5
(h) HEPA final filter, cartridge, each
(i) end plates, molded, inlet
(j) end plates, molded, outlet
(k) decal on the filter/vacuum unit
   IV. VRS/Carbon Canister Section
(a) carbon canister, without lid/top plate
(b) canister lid/top plate, with screws (5), ¼-20×¾ truss head
(c) foam gasket and 425 canister pad
(d) carbon, activated, 22 pounds
(e) snap-in handle
(f) standoff, mounting for canister, with screws
(g) trim, bottom edge
   V. Miscellaneous
(a) safety goggles
(b) gloves, lamp handling

Accordingly, while there has been shown the preferred embodiment of the present invention, it is to be understood that the invention may be embodied otherwise than is herein specifically shown and described and that within said embodiments certain changes may be made in the forms and arrangements of the parts without departing from the underlying ideas or principles of this invention.

1. A hazardous material and chemical waste storage and disposal system comprising:
means for receiving an object containing a hazardous material or chemical within;
means for breaking the received object to release the hazardous material or chemical;
means for collecting the broken object;
means for capturing a substantial amount of the released hazardous material or chemical; and
means for retaining the substantial amount of the released hazardous material or chemical.

2. The storage and disposal system of claim 1 wherein said means for receiving shaped similar to the object to be received.

3. The storage and disposal system of claim 1 wherein said means for breaking comprises:
a spinner assembly;
a motor assembly in communication with said spinner assembly; and
means for powering said motor assembly;
wherein when said object is fed through said means for receiving it is broken by said spinner assembly.

4. The storage and disposal system of claim 1 wherein said means for collecting is a housing having an interior area for receipt of the broken object.

5. The storage and disposal system of claim 4 wherein said housing is a drum.

6. The storage and disposal system of claim 1 wherein said means for capturing is a vacuum assembly.

7. The storage and disposal system of claim 1 wherein said means for retaining is a filtering system.

8. The storage and disposal system of claim 7 wherein said filtering system is an activated carbon filtering system.

9. A fluorescent lamp collection and disposal system, said fluorescent lamp containing a hazardous material comprising:
a housing having a cover member and defining an interior area;
a tube member associated with the cover member for receiving a fluorescent lamp;
means for breaking the fluorescent lamp received by said tube member, said means for breaking associated at an end of said tube member and breaking the fluorescent into a plurality of pieces;
a vacuum assembly including a hose member and disposed approximate the end of said tube member associated with said means for breaking, said vacuum assembly capturing a substantial amount of hazardous material released from the breaking of the fluorescent lamp; and
a filtering system for retaining captured hazardous material received through the hose member;
wherein the pieces of broken fluorescent lamp are disposed within the interior area of said housing.

10. The fluorescent lamp collection and disposal system of claim 9 wherein said tube member is substantially vertically oriented and a bottom end of said tube member is associated with said means for breaking.

11. The fluorescent lamp collection and disposal system of claim 9 wherein said means for breaking comprises:
a spinner assembly;
a motor assembly in communication with said spinner assembly; and
means for powering said motor assembly;
wherein when said fluorescent is fed through said tube member it is broken by said spinner assembly.

12. The fluorescent lamp collection and disposal system of claim 9 wherein said filtering system is an activated carbon filtering system.

13. The fluorescent lamp collection and disposal system of claim 9 wherein said housing is a drum.

14. The fluorescent lamp collection and disposal system of claim 9 wherein said housing is a 55 gallon drum.

15. The fluorescent lamp collection and disposal system of claim 9 wherein said tube member is substantially flexible.

16. The fluorescent lamp collection and disposal system of claim 10 wherein said cover member having an aperture disposed approximate to the bottom end of said tube member.

17. The fluorescent lamp collection and disposal system of claim 9 wherein said hazardous material is a mercury vapor.

18. A method for collecting and disposing of fluorescent lamps containing at least one hazardous material, said method comprising the steps of:
(a) inserting a fluorescent lamp into a receiving member;
(b) breaking the inserted fluorescent lamp into a plurality of pieces and releasing the contained at least one hazardous material;
(c) collection the plurality of pieces within an interior area of a housing;
(d) capturing a substantial portion of the released at least one hazardous material; and
(e) retaining the captured at least one hazardous material.

19. The method of claim 18 wherein step (e) comprises the step of directing the captured at least one hazardous material through a filtering system.

20. The method of claim 18 wherein steps (a) and (b) including the steps of inserting the fluorescent lamp through a tube member and to a spinner assembly disposed approximate an end of the tube member which breaks the fluorescent lamp into a plurality of pieces and releases the at least one hazardous material.
